(19) United States
(12) Patent Application Publication
(10) Pub. No.: US 2010/0059316 A1
(43) Pub. Date: Mar. 11, 2010

(54) AUTOMATIC LUBRICATION

(75) Inventors: Karl Waldeck, Etzenricht (DE); Karl Ruhland, Pfreimd (DE); Bernhard Jentsch, Mantel (DE)

Correspondence Address: BROWDY AND NEIMARK, P.L.L.C.;624 NINTH STREET, NW, SUITE 300, WASHINGTON, DC, 20001-5303, US

(73) Assignee: BHS Corrugated Maschinen-und Anlagenbuau GmbH, Weiherhammer (DE)

(21) Appl. No.: 12/555,087

(22) Filed: Sep. 8, 2009

(30) Foreign Application Priority Data
Sep. 6, 2008 (DE) 10 2008 046 153.9

(51) Int. Cl. B23Q 11/12

(52) U.S. Cl. 184/6.14

(57) ABSTRACT

The invention relates to a corrugated cardboard processing device comprising at least one tool carrier which is displaceably mounted transversely with respect to a transport direction of a corrugated cardboard web along at least one guide element, and a lubricating device for lubricating a bearing between the at least one tool carrier and the at least one guide element.

### FIELD OF THE INVENTION

The invention relates to a corrugated cardboard processing device with a lubricating device. The invention also relates to a method for the automatic lubrication of a corrugated cardboard processing device.

### BACKGROUND ART

An automatic cutting and grooving machine, such as is used in the processing of corrugated cardboard webs, generally has several 100 lubricating nipples, which have to be lubricated at regular intervals by the servicing staff with a grease gun. This is very laborious.

### SUMMARY OF THE INVENTION

The invention is therefore based on the object of providing a corrugated cardboard processing device, in which the lubricating process is improved, in particular facilitated.

This object is achieved according to the invention by a corrugated cardboard processing device comprising at least one tool carrier which is displaceably mounted transversely with respect to a transport direction of a corrugated cardboard web along at least one guide element and a lubricating device for lubricating a bearing between the at least one tool carrier and the at least one guide element. The object is further achieved by a method for automatically lubricating a corrugated cardboard processing device comprising the steps of providing a corrugated cardboard processing device with at least one tool carrier which is displaceably mounted along a guide element and a controllable lubricating device, and lubricating a bearing between the at least one tool carrier and the at least one guide element by means of the controllable lubricating device.

The core of the invention consists in providing a lubricating device for the automatic lubrication of the bearings in a corrugated cardboard processing device. For this purpose, it is provided, in particular, that at least one guide element is to be configured as a hollow shaft for supplying the lubricant to the bearings to be lubricated.

Features and details of the invention emerge from the description of a plurality of embodiments with the aid of the drawings.

### BRIEF DESCRIPTION OF THE DRAWINGS

FIG. 1 shows a schematic view of a corrugated cardboard processing device according to a first embodiment,

FIG. 2 shows a sectional view of the device according to FIG. 1 along the line II-II,

FIG. 3 shows an enlargement of a detail of the device according to FIG. 1,

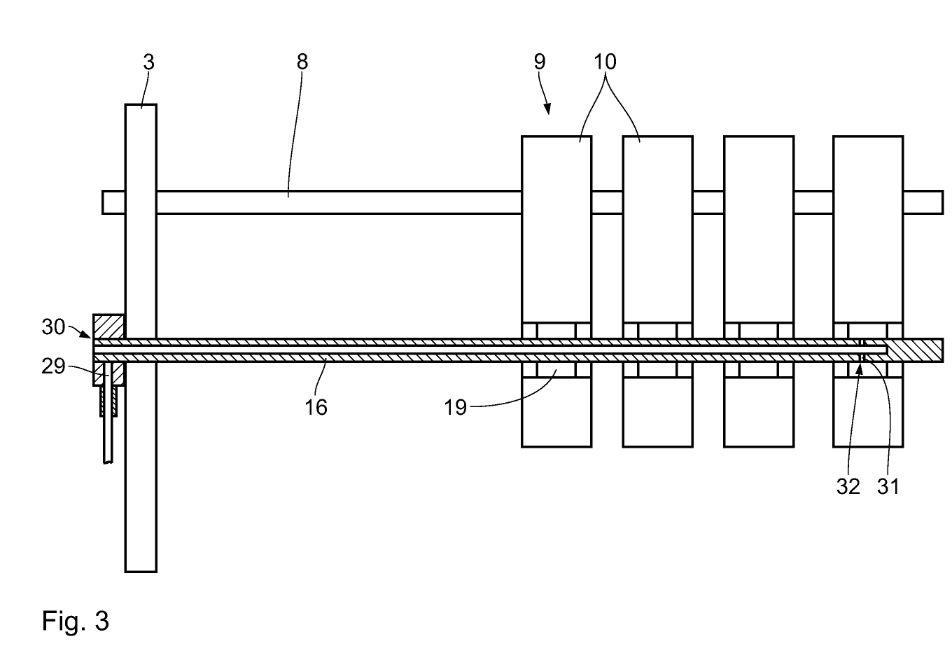

FIG. 4 shows a detailed view of a tool carrier according to a first embodiment,

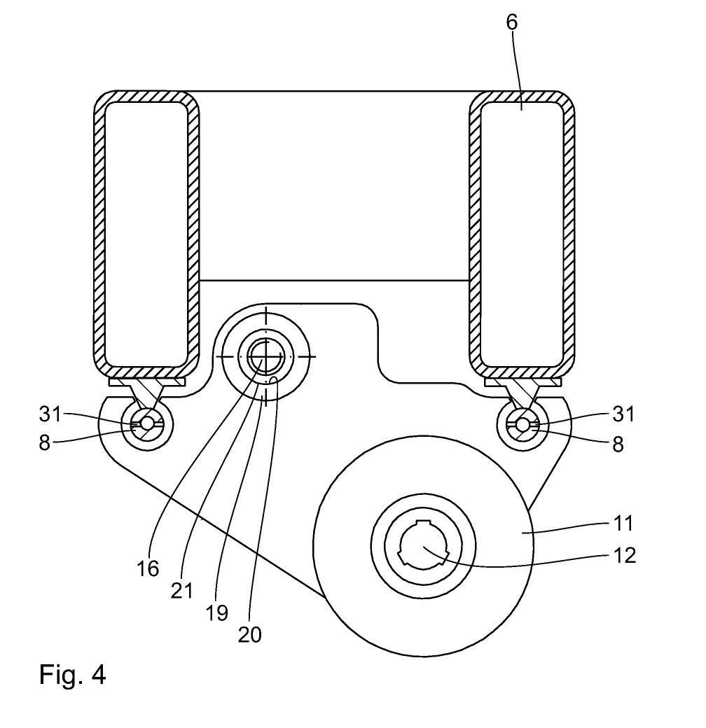

FIG. 5 shows a detailed view of a tool carrier according to a further embodiment and

FIG. 6 shows a hydraulic plan of a lubricant distributor of the device according to FIG. 1.

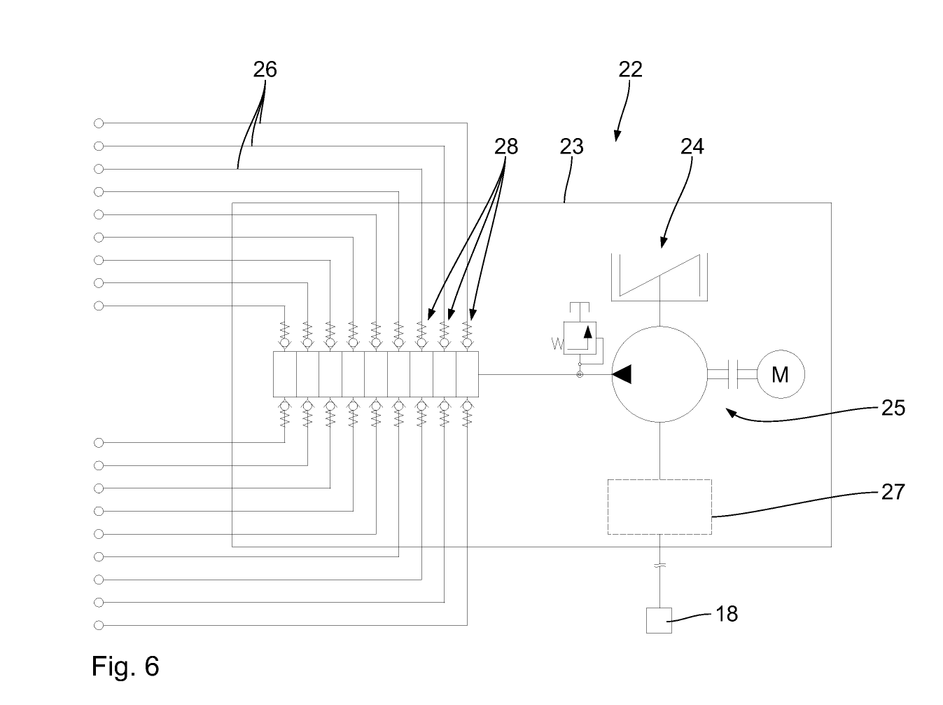

### DESCRIPTION OF THE PREFERRED EMBODIMENTS

A corrugated cardboard processing device 1, in particular for cutting and/or grooving a corrugated cardboard web 2, has a stationary machine frame 3, which is supported on the ground 4. Crossbeams 6 extending transversely with respect to a corrugated cardboard web 2 are arranged on the machine frame 3. The crossbeams 6 are configured as tool beds. They are in each case arranged pairwise one above the other mirror-symmetrically with respect to the corrugated cardboard web 2. The crossbeams 6 are in each case pivotably mounted about an axle in the machine frame 3. Pivot drives 7 configured, in particular, as a spindle-nut drive, are provided to pivot the crossbeams 6.

Guide rails 8 are attached to the respective sides of the crossbeams 6 facing the corrugated cardboard web 2. The guide rails 8 are also called linear bearings and form a first guide element. Two respective guide rails 8 are provided on each crossbeam 6. Tool carriers 9 in turn associated with one another pairwise are displaceably mounted transversely with respect to the transport direction 5 on the guide rails 8. The tool carriers 9 in each case comprise a guide block 10. A tool 11 is rotatably mounted in each case about a tool axle 12 on the guide block 10 arranged above the corrugated cardboard web 2. The tool axle 12 is oriented, in particular, perpendicularly with respect to the transport direction 5. Accordingly, a counter-tool 13 is in each case rotatably mounted about a counter-tool axle 14 on the guide block 10 arranged below the corrugated cardboard web 2. The tools 11 and counter-tools 13 may be grooving tools to produce a longitudinal grooving in the transport direction 5 in the corrugated cardboard web 2 or blades, in particular circular blades, for longitudinally cutting the corrugated cardboard web 2. The tools 11 and counter-tools 13 may be driven by a rotary drive known, for example, from EP 0 922 543 A2. Moreover, the tools 11 or counter-tools 13 may in each case also be configured as a counter-holding table 15. Reference is made to EP 0 922 543 A2 for details in this regard.

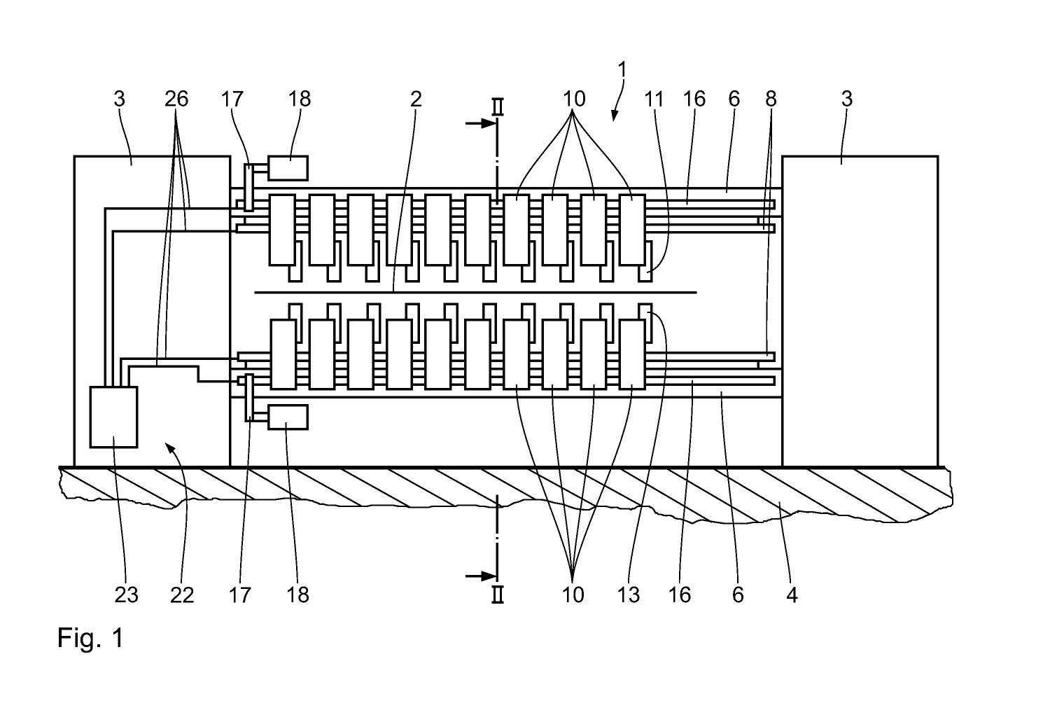

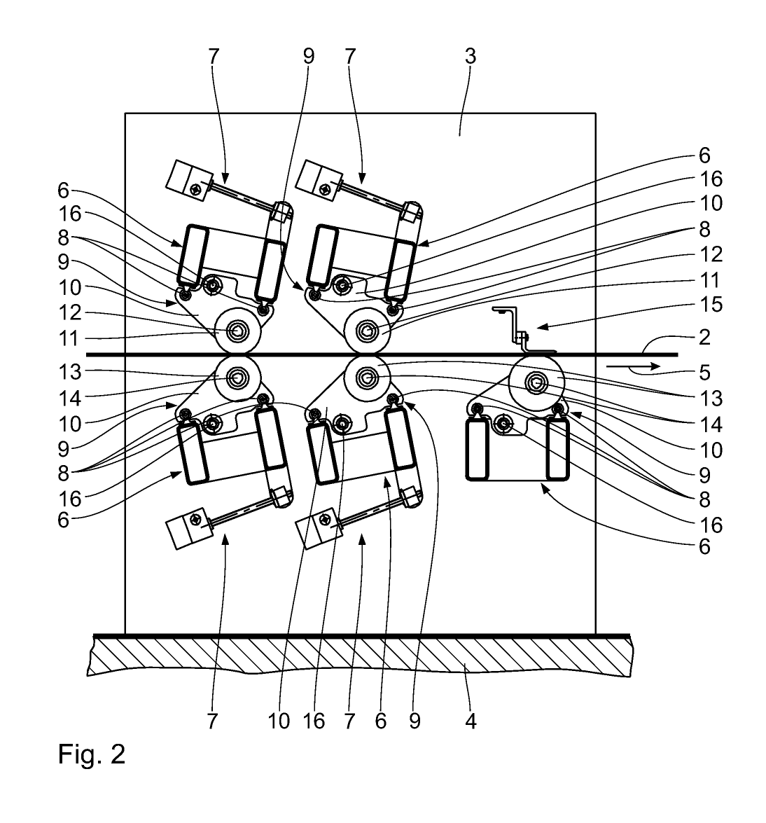

The tools 11 and counter-tools 13 are in each case pivotable by means of the pivot drive 7 into an engagement position shown in FIG. 2, in which they engage with the corrugated cardboard web. Accordingly, the tools 11 and counter-tools 13 can be pivoted by means of the pivot drives 7 into a parking position shown in FIG. 1, in which they are not in engagement with the corrugated cardboard web 2. The corrugated cardboard web 2 is therefore guided through, without contact, between the tools 11 and the counter-tools 13, if these are in the parking position.

The tool carriers 9 can in each case be displaced on the crossbeam 6 in the direction of the tool axle 12, in other words transversely with respect to the transport direction 5. A regulating shaft, which is configured as a threaded spindle 16 and is rotatably mounted in the machine frame 3, is provided to displace the tool carriers 9 transversely with respect to the transport direction 5. The threaded spindle 16 forms a second guide element. To drive the threaded spindles 16, a respective positioning motor 18 connected thereto by means of a toothed belt 17 is provided. Each tool carrier 9 has a spindle nut 19, which is arranged in the threaded spindle 16, with an internal thread 20, which engages in an external thread 21 of the threaded spindle 16 which fits therewith. The spindle nut 19, like the bearings of the tool carrier 9 on the guide rails 8, forms a tool carrier bearing.

Advantageously, a coupling, not shown in the figures, is provided on each tool carrier 9, by means of which the free rotatability of the spindle nut 19 relative to the tool carrier 9 can be prevented, in other words by means of which the spindle nut 19 can be non-rotatably connected to the respective tool carrier 9. Reference is made to DE 100 38 511 A1 for details with respect to this.

Moreover, the corrugated cardboard processing device 1 comprises a lubricating device 22 for lubricating the bearings between the tool carriers 9 and the guide elements 8, 16. The lubricating device 22 comprises a lubricant distributor 23 with at least one lubricant container 24. The lubricant distributor 23 has a pump 25 and a plurality of lubricant lines 26. Moreover, a control unit 27 is provided to control the lubricating device 22, by means of which the lubrication of the bearings can be carried out in an automated manner The control unit 27 can preferably be programmed. The lubricant lines 26 are in each case connected by means of a controllable valve 28 via the pump 25 to the lubricant container 24.

To supply the lubricant to the bearings to be lubricated, the threaded spindles 16 and the guide rails 8 are in each case configured as a hollow shaft or hollow profile with a longitudinal bore. The hollow shafts are sealed at the end. The hollow shafts or hollow profiles may have any external cross section, in particular a rectangular or round cross section. To introduce lubricant into the hollow shafts, a rotary lead-through 29 is provided in at least one shaft bearing 30 arranged on the machine frame 3. The hollow shafts are in each case connected to one of the lubricant lines 26 of the lubricant distributor 23 by means of the rotary lead-through 29. A separate lubricant line 26 is associated here in each case with one of the threaded spindles 16. Likewise, a respective separate lubricant line 26 is associated with each of the guide rails 8. Thus, the hollow shafts can be loaded individually, in a controllable manner, with lubricant by means of the valves 28 which can be controlled by the control unit 27.

A transverse bore 31 is provided at one respective point in the direction transverse with respect to the transport direction 5 in each of the hollow shafts. The transverse bore 31 in each case defines, on the hollow shafts, a lubricating position 32, at which lubricant can discharge from the hollow shafts to lubricate the bearings. The lubricating position 32 on the threaded spindle 16 and the lubricating position 32 on the guide rails 8 are in each case arranged flush with one another in the transport direction 5 so the tool carrier 9, when it is at the lubricating position 32 of the threaded spindle 16, also specifically adopts the lubricating position 32 with respect to the guide rails 8.

To lubricate the bearings of a specific tool carrier 9, the latter has to be displaced transversely with respect to the transport direction 5 to the lubricating position 32. For this purpose, the control unit 27 is coupled to the positioning motor 18.

The mode of functioning of the lubricating device 22 will be described below. For automatic lubrication of the corrugated cardboard processing device 1, in each case, one of the tool carriers 9 is displaced to the lubricating position 32 by means of the threaded spindle 16 driven by the positioning motor 18. In this position of the tool carrier 9, the lubricant line 26 leading to the corresponding threaded spindle 16 is loaded with lubricant by a controlled opening of its associated valve 28 by the lubricant distributor 23. The lubricant arrives from the lubricant container 24 through the rotary lead-through 29 into the threaded spindle 16 configured as a hollow shaft and arrives through the longitudinal bore in the interior of the threaded spindle 16 at the transverse bore 31, through which it discharges to lubricate the bearing of the respective tool carrier 9.

The bearings of the tool carrier 9 on the guide rails 8 are lubricated in a corresponding manner.

After the lubrication of the bearings of a tool carrier 9, the latter is removed from the lubricating position 32, so the next tool carrier 9 can be displaced for lubrication to the lubricating position 32. The tool carriers 9 are therefore displaced one after the other to the lubricating position 32 for lubrication.

The displacement of the tool carriers 9 can advantageously be carried out in an automated manner by means of the control unit 27, so a lubricating programme now only has to be started by means of the control unit 27 to lubricate the entire corrugated cardboard processing device 1. As the corrugated cardboard processing device 1 may have more than 100 tool carriers 9, the bearings of which on the threaded spindle 16 and the guide rails 8 can often only be accessed with difficulty, the outlay for this is substantially reduced owing to the automated lubrication which can be carried out by means of the lubricating device 22.

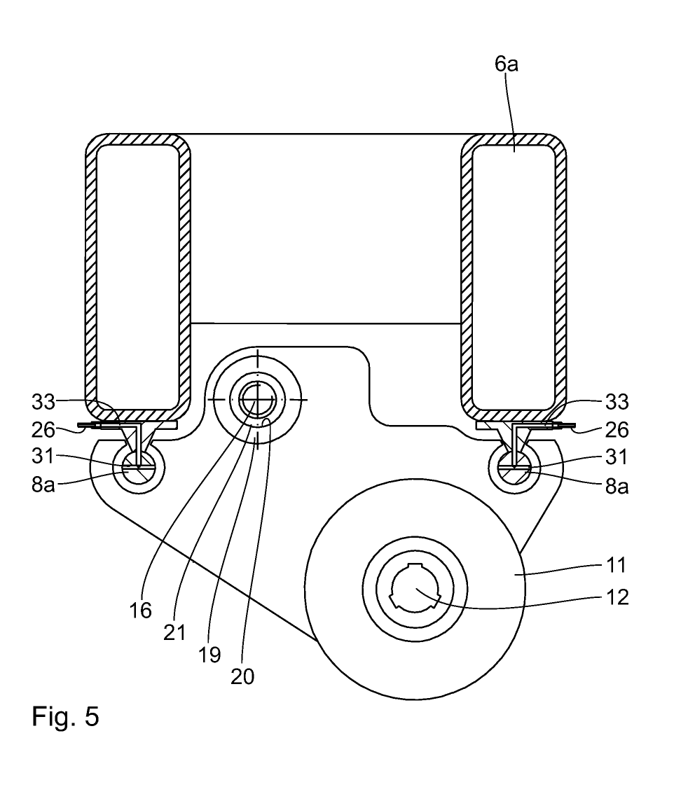

A second embodiment of the lubricating device 22 will be described below with reference to FIG. 5. Identical parts receive the same reference numerals as in the first embodiment, the description of which is herewith referred to. Structurally different but functionally similar parts receive the same reference numerals with an a placed thereafter. The difference from the first embodiment is that the guide rails 8a are supplied with lubricant by means of a lubricant feed 33 integrated in the crossbeam 6a. It is therefore not necessary in this embodiment to configure the guide rails 8a as hollow shafts. This is advantageous, in particular, when an already existing corrugated cardboard processing device 1 with already existing guide rails 8a is to be retrofitted with a lubricating device according to the invention. For this purpose, the lubricating feeds 33 would merely have to be attached to the crossbeams 6a and connected to the lubricant lines 26 of the lubricant distributor 23 and the guide rails 8a provided with the transverse bores 31. The regulating shaft present optionally has to be replaced by a hollow threaded spindle 16 according to the invention.

What is claimed is:

1. A corrugated cardboard processing device (1) comprising
a. at least one tool carrier (9) which is displaceably mounted transversely with respect to a transport direction (5) of a corrugated cardboard web (2) along at least one guide element (8, 16; 8a, 16) and
b. a lubricating device (22) for lubricating a bearing between the at least one tool carrier (9) and the at least one guide element (8, 16; 8a, 16).

2. A device according to claim 1, wherein the at least one guide element (8, 16) is configured as a hollow profile.

3. A device according to claim 1, wherein the at least one guide element (8, 16) is configured as a hollow shaft.

4. A device according to claim 3, wherein at least one transverse bore (31) is provided in the hollow shaft.

5. A device according to claim 1, wherein a lubricant distributor (23) with at least one lubricant container (24) is provided.

6. A device according to claim 5, wherein the lubricant distributor (23) has a pump (25) and at least one lubricant line (26).

7. A device according to claim 3, wherein a respective rotary leadthrough (29) is provided in at least one bearing of the hollow shaft to introduce lubricant into the at least one hollow shaft.

8. A device according to claim 1, wherein a control unit (27) is provided to control the lubricating device (22), by means of which the lubrication of the bearings can be carried out in an automated manner

9. A device according to claim 1, wherein the at least one guide element (8; 8a) is configured as a guide rail (8; 8a).

10. A device according to claim 1, wherein the at least one guide element (16) is configured as a threaded spindle (16).

11. A method for automatically lubricating a corrugated cardboard processing device (1) comprising the following steps:
a. providing a corrugated cardboard processing device (1) with
i. at least one tool carrier (9) which is displaceably mounted along a guide element (8, 16; 8a, 16) and
ii. a controllable lubricating device (22),
b. lubricating a bearing between the at least one tool carrier (9) and the at least one guide element (8, 16; 8a, 16) by means of the controllable lubricating device (22).

12. A method according to claim 11, wherein the tool carrier (9) is displaced on the at least one guide element (8, 16; 8a, 16) for lubrication to a specific lubricating position (32).

13. A method according to claim 12, wherein a plurality of tool carriers (9) displaceably mounted along a guide element (8, 16; 8a, 16) are displaced one after the other for lubrication to the lubricating position (32).
